(19) United States
(12) Patent Application Publication
(10) Pub. No.: US 2026/0187387 A1
(43) Pub. Date: Jul. 2, 2026

(54) MOBILE ELECTRONIC DEVICE AND REAL-TIME CALL TRANSLATION METHOD THEREOF

(71) Applicant: ASUSTeK COMPUTER INC., Taipei City (TW)

(72) Inventors: Yi-Hsin Shang, Taipei City (TW); Jen-Pang Hsu, Taipei City (TW); Chao-Hsien Huang, Taipei City (TW)

(73) Assignee: ASUSTeK COMPUTER INC., Taipei City (TW)

(21) Appl. No.: 19/438,668

(22) Filed: Jan. 2, 2026

(30) Foreign Application Priority Data
Jan. 2, 2025 (TW) 114100139

(51) Int. Cl. G06F 40/58; G10L 13/02; G10L 21/034; G10L 25/51; G10L 25/93

(52) U.S. Cl. CPC G06F 40/58; G10L 13/02; G10L 21/034; G10L 25/51; G10L 25/93

(57) ABSTRACT

Provided are a mobile electronic device and a real-time call translation method thereof. The method is adapted to the mobile electronic device including a microphone, and the method includes the following steps. Environmental sound level is detected when initiating a voice call. A speech recognition parameter is determined based on the environmental sound level. Speech recognition processing is performed on a call voice signal received by the microphone according to the speech recognition parameter to obtain a dialogue text. The dialogue text corresponding to a first language is translated to generate a translated dialogue text corresponding to a second language. During the voice call, a function is executed based on the translated dialogue text.

### CROSS-REFERENCE TO RELATED APPLICATION

This application claims the priority benefit of Taiwan application Ser. No. 114100139, filed on Jan. 2, 2025. The entirety of the above-mentioned patent application is hereby incorporated by reference herein and made a part of this specification.

### BACKGROUND

### Technical Field

This disclosure relates to a mobile electronic device and a real-time call translation method thereof.

### Related Art

With the rapid development of communication technology, an increasing number of electronic devices support voice call functionality between devices, providing modern people with more diverse and convenient communication options. Currently, the sound quality, stability, and continuity of voice call functionality have significantly improved, maintaining clear and smooth call experiences even in harsh environments or high-speed movement situations. However, in work, travel, and daily life, modern people increasingly need to communicate with individuals from different language backgrounds. During voice calls, if both parties use different languages, the parties may be unable to effectively convey and understand messages due to language ability limitations, thereby reducing communication efficiency.

### SUMMARY

This disclosure provides a real-time call translation method, adapted to a mobile electronic device including a microphone, and the method includes the following steps. Environmental sound level is detected when initiating a voice call. A speech recognition parameter is determined based on the environmental sound level. Speech recognition processing is performed on a call voice signal received by the microphone according to the speech recognition parameter to obtain a dialogue text. The dialogue text corresponding to a first language is translated to generate a translated dialogue text corresponding to a second language. During the voice call, a function is executed based on the translated dialogue text.

This disclosure also provides a mobile electronic device, which includes a microphone and a processor. The processor is coupled to the microphone and configured to perform the following operations. Environmental sound level is detected when initiating a voice call. A speech recognition parameter is determined based on the environmental sound level. Speech recognition processing is performed on a call voice signal received by the microphone according to the speech recognition parameter to obtain a dialogue text. The dialogue text corresponding to a first language is translated to generate a translated dialogue text corresponding to a second language. During the voice call, a function is executed based on the translated dialogue text.

Based on the above, in the embodiments of the disclosure, the speech recognition parameter may be determined based on the environmental sound level of the call environment, in order to improve the accuracy of speech recognition processing based on the speech recognition parameter. The dialogue text in the first language generated by the speech recognition processing may be translated into the translated dialogue text in the second language. During the voice call, a function may be executed according to the real-time translated dialogue text. As a result, in the embodiments of the disclosure, the quality of call translation can be effectively improved, making real-time translation during the call more convenient and satisfactory.

### BRIEF DESCRIPTION OF THE DRAWINGS

FIG. 1 is a schematic diagram of a mobile electronic device according to an embodiment of the disclosure.

FIG. 2 is a flowchart of a real-time call translation method according to an embodiment of the disclosure.

FIG. 3 is a flowchart of determining EOS timeout according to an embodiment of the disclosure.

FIG. 4 is a flowchart of determining EOS timeout according to an embodiment of the disclosure.

FIG. 5 is a flowchart of the real-time call translation method according to an embodiment of the disclosure.

FIG. 6 is a flowchart of determining a microphone sensitivity and an equalizer gain according to an embodiment of the disclosure.

FIG. 7 is a schematic diagram of the real-time call translation method according to an embodiment of the disclosure.

### DESCRIPTION OF THE EMBODIMENTS

Reference will now be made in detail to exemplary embodiments of the disclosure, examples of embodiments are illustrated in the accompanying drawings. Wherever possible, the same reference signs are used in the drawings and the description to refer to the same or like parts. These embodiments are merely a part of the disclosure and do not disclose all possible implementations of the disclosure. More precisely, the embodiments are merely examples of the device and method within the scope of the appended claims of the disclosure.

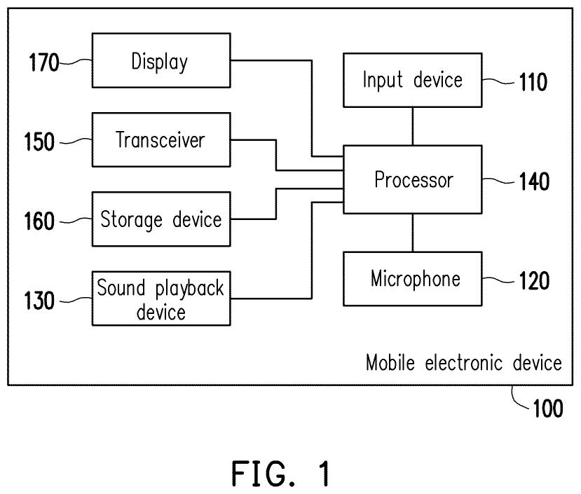

Referring to FIG. 1, a mobile electronic device 100 may be, for example, a smartphone, a tablet computer, or other electronic devices with communication functions. This disclosure does not limit the type of the device. The mobile electronic device 100 includes an input device 110, a microphone 120, a sound playback device 130, a processor 140, a transceiver 150, a storage device 160, and a display 170. The processor 140 is coupled to the input device 110, the microphone 120, the sound playback device 130, the transceiver 150, the storage device 160, and the display 170. The functions of the components are described as follows.

The input device 110 may be, for example, a touch device, buttons, or keyboard, used to receive user input. The user may issue user instructions through the input device 110.

The microphone 120 is used to convert sound waves into electronic signals. The microphone 120 may be, for example, a dynamic microphone, a condenser microphone, or an electret condenser microphone, and the disclosure is not limited thereto.

The sound playback device 130 has audio playback functionality, including components for playing call audio such as an earpiece, loudspeaker, or headphones. For example, when the mobile electronic device 100 operates in an earpiece mode, the user may hear call audio through the earpiece. When the mobile electronic device 100 operates in a speaker mode, the user may hear call audio through the loudspeaker. When the mobile electronic device 100 operates in a headphone mode, the user may hear call audio through the headphones.

The transceiver 150 may transmit and receive signals wirelessly. The transceiver may further perform operations such as low-noise amplification, impedance matching, mixing, up or down frequency conversion, filtering, amplification, and similar operations. The mobile electronic device 100 may receive and send voice call content through the transceiver 150. In some embodiments, the mobile electronic device 100 may further include an antenna (not shown) for receiving wireless radio frequency signals.

The storage device 160 is used to store files, instructions, codes, software modules, and other data, and may be, for example, any type of fixed or removable random access memory (RAM), read-only memory (ROM), flash memory, hard drive, or other similar devices, integrated circuits, or combinations thereof.

The display 170 may include a liquid crystal display (LCD), light-emitting diode (LED) display, organic light-emitting diode (OLED) display, or other types of displays, and the disclosure is not limited thereto. In some embodiments, the display 170 may be integrated with a touch device to form a touch screen.

The processor 140 may be, for example, a central processing unit (CPU), an application processor (AP), or other programmable general-purpose or special-purpose microprocessors, a digital signal processor (DSP), a programmable controller, an application specific integrated circuit (ASIC), a programmable logic device (PLD), a graphics processing unit (GPU), or other similar devices, or combinations of these devices. The processor 140 may execute, for example, codes, software modules, and instructions stored in the storage device 160 to implement the real-time call translation method of the embodiments of the disclosure. The above-mentioned software modules may be broadly interpreted to mean, for example, instructions, instruction sets, codes, program codes, programs, applications, software packages, threads, processes, and functions.

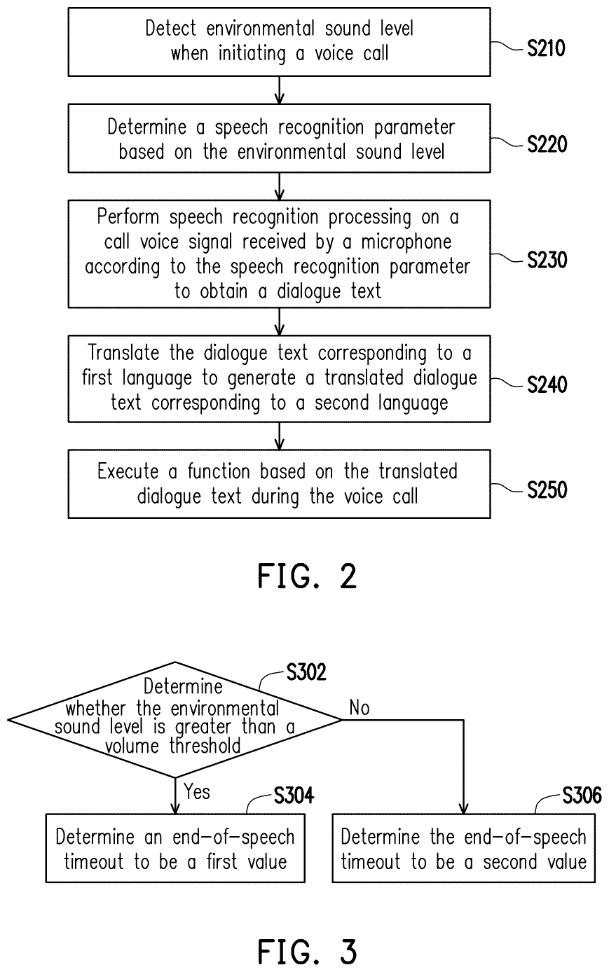

Referring to FIG. 1 and FIG. 2, a method of this embodiment is adapted to the mobile electronic device 100 in the previous embodiment. The following will explain the detailed steps of the real-time call translation method of this embodiment in conjunction with the various components in the mobile electronic device 100.

In Step S210, when initiating a voice call, the processor 140 may detect the environmental sound level. The voice call may be established based on various VoIP applications or other telephone applications. In some embodiments, the processor 140 uses the microphone 120 to detect the environmental sound level.

In some embodiments, while waiting for the voice call to connect, the processor 140 may receive environmental audio through the microphone 120 and calculate the environmental sound level based on the environmental audio. In detail, the processor 140 may use root mean square (RMS) or fast Fourier transform (FFT) techniques through an audio digital processor to extract the sound pressure level (SPL) from the environmental audio to quantify the magnitude of the environmental sound level.

In some embodiments, the processor 140 may determine whether the mobile electronic device 100 is in an indoor environment or an outdoor environment based on the environmental sound level. When the environmental sound level is greater than a volume threshold, the processor 140 may determine that the mobile electronic device 100 is in an outdoor environment. When the environmental sound level is not greater than the volume threshold, the processor 140 may determine that the mobile electronic device 100 is in an indoor environment.

In Step S220, the processor 140 may determine a speech recognition parameter based on the environmental sound level. In detail, the processor 140 may dynamically adjust the configuration value of the speech recognition parameter by detecting the magnitude of the environmental sound level. When the environmental sound level is greater than the volume threshold (determining that the mobile electronic device 100 is in the outdoor environment), the processor 140 may configure the speech recognition parameter to a certain value. When the environmental sound level is not greater than the volume threshold (determining that the mobile electronic device 100 is in the indoor environment), the processor 140 may configure the speech recognition parameter to another value.

In some embodiments, the speech recognition parameter may include an end-of-speech timeout (EOS timeout) for speech recognition processing. In detail, the end-of-speech timeout is used to segment speech input passages in speech recognition processing. When the processor 140 detects that the silent time exceeds the set end-of-speech timeout, the processor 140 may consider the speech signal before the silence as a speech segment, and then begin subsequent speech recognition processing on that speech segment. From another perspective, the end-of-speech timeout may be used to segment speech passages based on pauses in the speech of the user.

Please refer to FIG. 3, which is a flowchart of determining the EOS timeout according to an embodiment of the disclosure. In Step S302, the processor 140 may determine whether the environmental sound level is greater than the volume threshold. The volume threshold may be set according to practical applications, and the disclosure is not limited thereto. When the environmental sound level is greater than the volume threshold, in Step 304, the processor 140 may determine the end-of-speech timeout to be a first value. When the environmental sound level is not greater than the volume threshold, in Step 306, the processor 140 may determine the end-of-speech timeout to be a second value. Here, the second value is greater than the first value.

In detail, when the environmental sound level is greater than the volume threshold, the processor 140 determines that the mobile electronic device 100 is in an outdoor or noisy environment, and thus sets the end-of-speech timeout to a shorter first value. In this way, by using a smaller end-of-speech timeout, the operation may avoid interference from invalid audio in the outdoor or noisy environment during the recognition process. Conversely, when the environmental sound level does not exceed the volume threshold, the processor 140 determines that the mobile electronic device 100 is in an indoor or quiet environment, and thus sets the end-of-speech timeout to a longer second value, allowing for more natural pauses and thus improving the completeness of recognition.

In some embodiments, the processor 140 may determine the end-of-speech timeout based on the call mode of the voice call and the environmental sound level. In other words, the processor 140 may dynamically set the end-of-speech timeout based on different call modes of the voice call. The call mode of the voice call may be a speaker mode or an earpiece mode.

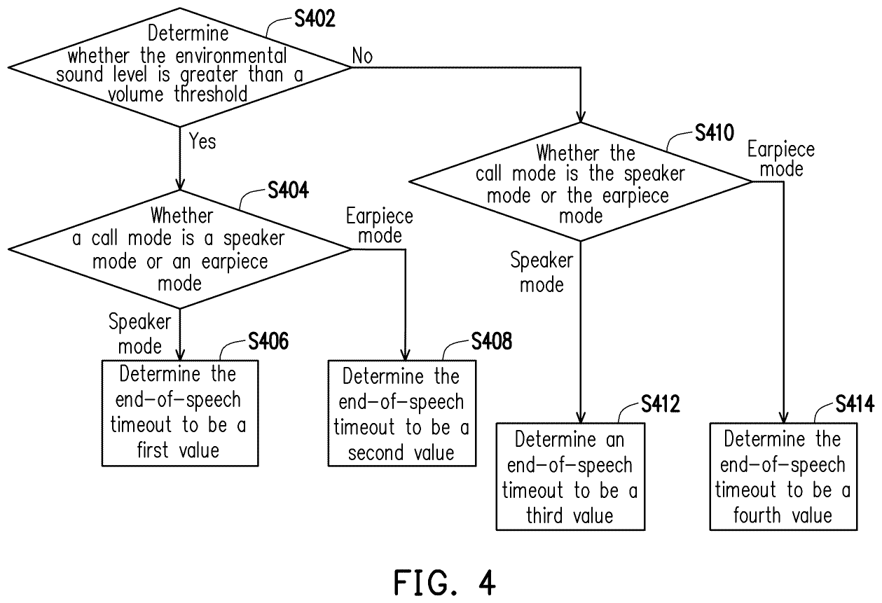

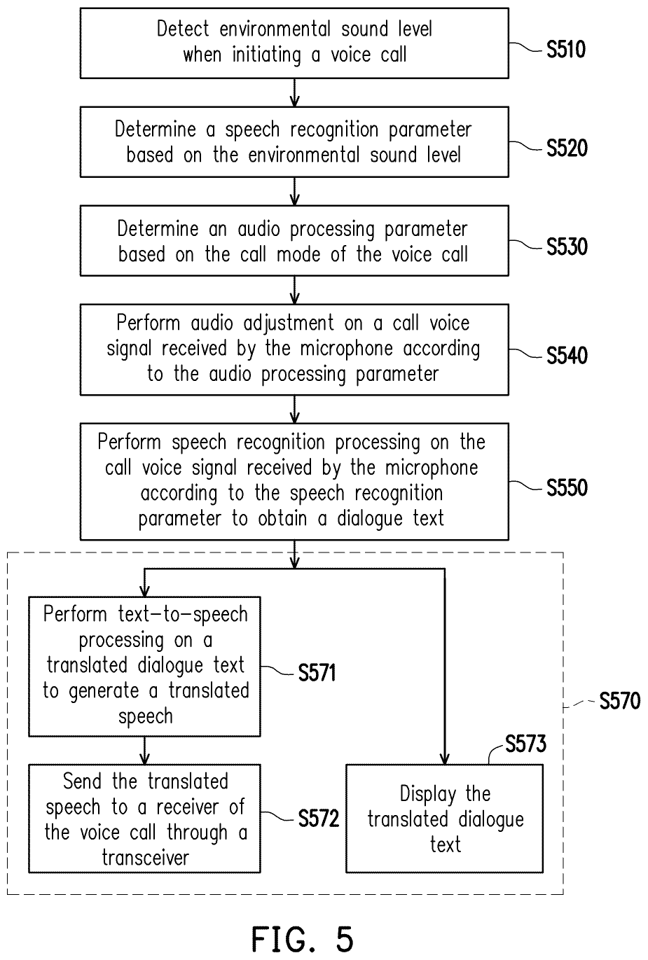

Please refer to FIG. 4, which is a flowchart of determining the EOS timeout according to an embodiment of the disclosure. In Step S402, the processor 140 may determine whether the environmental sound level is greater than the volume threshold. That is, the processor 140 may determine whether the mobile electronic device 100 is in an indoor environment or an outdoor environment. The processor 140 may determine whether the mobile electronic device 100 is in a noisy environment or a quiet environment.

When the environmental sound level is greater than the volume threshold, in Step S404, the processor 140 may determine whether the call mode is the speaker mode or the earpiece mode. When the environmental sound level is greater than the volume threshold and the call mode is the speaker mode, in Step S406, the processor 140 may determine the end-of-speech timeout to be the first value. On the other hand, when the environmental sound level is greater than the volume threshold and the call mode is the earpiece mode, in Step S408, the processor 140 may determine the end-of-speech timeout to be the second value. The second value is greater than the first value.

When the environmental sound level is not greater than the volume threshold, in Step S410, the processor 140 may determine whether the call mode is the speaker mode or the earpiece mode. When the environmental sound level is not greater than the volume threshold and the call mode is the speaker mode, in Step S412, the processor 140 may determine the end-of-speech timeout to be a third value. On the other hand, when the environmental sound level is not greater than the volume threshold and the call mode is the earpiece mode, in Step S414, the processor 140 may determine the end-of-speech timeout to be a fourth value. The fourth value is greater than the third value, and the third value is greater than the second value.

In detail, when operating in the speaker mode, the mouth of the user is farther from the microphone 120, making the voice call more susceptible to environmental noise interference. Therefore, when operating in the speaker mode, setting the end-of-speech timeout to a shorter value may avoid interference from invalid audio in the outdoor or noisy environment during the recognition process. Furthermore, when operating in the earpiece mode, the mouth of the user is closer to the microphone 120, and external noise has less interference on the call. Therefore, when operating in the earpiece mode, the end-of-speech timeout is set to a longer value.

For example, when the environmental sound level is greater than the volume threshold and the call mode is the speaker mode, the processor 140 may determine the end-of-speech timeout to be 250 milliseconds (ms). When the environmental sound level is greater than the volume threshold and the call mode is the earpiece mode, the processor 140 may determine the end-of-speech timeout to be 500 milliseconds (ms). When the environmental sound level is not greater than the volume threshold and the call mode is the speaker mode, the processor 140 may determine the end-of-speech timeout to be 750 milliseconds (ms). When the environmental sound level is not greater than the volume threshold and the call mode is the earpiece mode, the processor 140 may determine the end-of-speech timeout to be 1000 milliseconds (ms). However, the values are merely for illustrative purposes and are not intended to limit the scope of this disclosure.

In Step S230, the processor 140 may perform speech recognition processing according to the speech recognition parameter and the call voice signal received by the microphone 120 to obtain a dialogue text. In detail, the processor 140 may convert the spoken speech content from the user into the dialogue text through speech recognition processing. In some embodiments, the processor 140 may use a speech recognition model to generate the dialogue text. The speech recognition model may be a Transformer-based speech processing model for executing speech-to-text tasks, such as the Whisper model, but the disclosure is not limited thereto. The speech recognition model may extract audio features from the call voice signal, such as Mel-spectrogram features, and map the audio features to text sequences, thereby generating the dialogue text based on the call voice signal.

In Step S240, the processor 140 may translate the dialogue text corresponding to a first language to generate a translated dialogue text corresponding to a second language. In some embodiments, the processor 140 may use a neural network-based translation model to translate the recognized dialogue text into the target language (that is, the second language). The translation model may be, for example, a GPT model, but the disclosure is not limited thereto.

In Step S250, during the voice call, the processor 140 may execute a function based on the translated dialogue text. For example, the processor 140 may generate speech by processing the translated dialogue text through text-to-speech (TTS) and transmit to the other party in real-time. Additionally, the processor 140 may display the translated dialogue text as subtitles on the interface of the call application for reference by both parties on the call.

Referring to FIG. 1 and FIG. 5, the method of this embodiment is adapted to the mobile electronic device 100 in the previous embodiment. The following will explain the detailed steps of the real-time call translation method of this embodiment in conjunction with the various components in the mobile electronic device 100.

In Step S510, when initiating a voice call, the processor 140 may detect the environmental sound level. In Step S520, the processor 140 may determine a speech recognition parameter based on the environmental sound level. The detailed implementation of Steps S510 to S520 may be referred to in the previous embodiment, so details will not be repeated here.

In Step S530, the processor 140 may determine an audio processing parameter based on the call mode of the voice call. In Step S540, the processor 140 may perform audio adjustment on the call voice signal received by the microphone 120 according to the audio processing parameter. In detail, in some embodiments, to improve the accuracy of speech recognition processing, the processor 140 may perform the audio adjustment on the call voice signal received by the microphone 120 through an audio DSP (digital signal processor). The audio DSP may dynamically set the audio processing parameter based on the call mode of the voice call. The processor 140 may control the audio DSP to perform the audio adjustment according to the corresponding audio processing parameter based on the call mode of the voice call.

In some embodiments, the audio processing parameter adjusted based on the call mode may include a microphone sensitivity. The microphone sensitivity is used to determine the sound pickup capability of the microphone 120, and the microphone sensitivity determines the degree of response of the microphone 120 to sound pressure. In some embodiments, the audio DSP may adjust the microphone sensitivity by adjusting the amplification gain, in which the amplification gain is the amplification magnitude of the audio DSP for amplifying the input audio (that is, the call voice signal received by the microphone 120) captured by the microphone 120.

In some embodiments, the call mode may include the speaker mode or the earpiece mode, and the microphone sensitivity in the speaker mode is higher than the microphone sensitivity in the earpiece mode. For example, the microphone sensitivity in the speaker mode may increase by 23 dB relative to a baseline, while the microphone sensitivity in the earpiece mode may increase by 9 dB relative to that baseline. However, the values are merely for demonstrative purposes, and are not intended to limit the disclosure. The baseline is, for example, the microphone sensitivity used when the call translation function is not enabled.

In some embodiments, the audio processing parameter adjusted based on the call mode may include an equalizer gain (EQ gain). The equalizer gain may be used as an audio processing parameter to control the audio intensity of different frequency ranges. By adjusting the gain values of different frequency bands, the call voice signal captured by the microphone 120 may be amplified or attenuated to optimize audio quality and improve speech recognition accuracy.

In some embodiments, when the call mode is the speaker mode, the processor 140 may adjust the equalizer gain corresponding to a first frequency range. When the call mode is the earpiece mode, the equalizer gain corresponding to a second frequency range is adjusted. The first frequency range is different from the second frequency range. In other words, in response to the call mode being the speaker mode or the earpiece mode, the processor 140 may determine to process different frequency ranges of the call voice signal. When the call mode is the speaker mode, the processor 140 may control the audio DSP to attenuate the low-frequency portion and high-frequency portion of the call voice signal. When the call mode is the earpiece mode, the processor 140 may control the audio DSP to enhance the mid-frequency portion of the call voice signal, in which the mid-frequency portion is the main frequency band of human voice. That is to say, when the call mode is the speaker mode, the processor 140 may reduce the degree of noise interference by attenuating the low-frequency portion and high-frequency portion of the call voice signal. When the call mode is the earpiece mode, the processor 140 may make human voice clearer by enhancing the mid-frequency portion of the call voice signal.

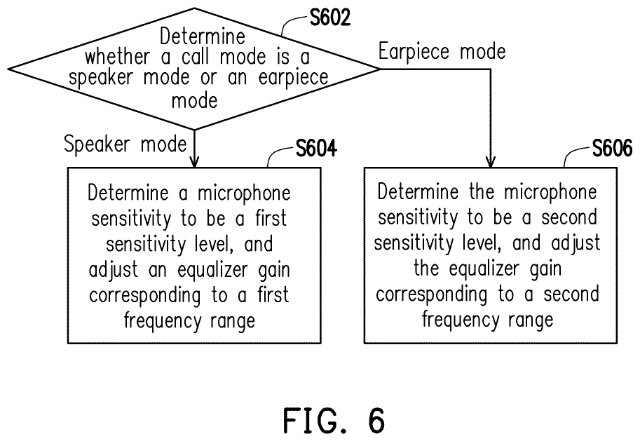

Please refer to FIG. 6, which is a flowchart of determining the microphone sensitivity and the equalizer gain according to an embodiment of the disclosure. In Step S602, the processor 140 may determine whether the call mode is the speaker mode or the earpiece mode. When the call mode is the speaker mode, in Step S604, the processor 140 may determine the microphone sensitivity to be a first sensitivity level, and adjust the equalizer gain corresponding to the first frequency range. When the call mode is the earpiece mode, in Step S606, the processor 140 may determine the microphone sensitivity to be a second sensitivity level, and adjust the equalizer gain corresponding to the second frequency range.

For example, when the call mode is the speaker mode, the processor 140 may control the audio DSP to perform gain adjustment of −20 dB at 10 Hz frequency, and a gain adjustment of −10 dB at 8000 Hz frequency. When the call mode is the earpiece mode, the processor 140 may control the audio DSP to perform a gain adjustment of +8 dB at 850 Hz frequency. However, the values are merely for demonstrative purposes, and are not intended to limit the disclosure. Moreover, the baseline value for gain adjustment may be, for example, the gain value used when the call translation function is not enabled.

In Step S550, the processor 140 may perform speech recognition processing on the call voice signal received by the microphone 120 according to the speech recognition parameter to obtain the dialogue text. In Step S560, the processor 140 may translate the dialogue text corresponding to the first language to generate the translated dialogue text corresponding to the second language. The detailed implementation of Steps S550 to S560 may be referred to in the previous embodiment, so details will not be repeated here.

In Step S570, during the voice call, the processor 140 may execute a function based on the translated dialogue text. In some embodiments, Step S570 may be implemented as Steps S571 to S573.

In Step S571, the processor 140 may perform text-to-speech processing on the translated dialogue text to generate a translated speech. In other words, the processor 140 may generate an audio file of a target language speech. In Step S572, the processor 140 may send the translated speech to the receiver of the voice call through the transceiver 150. In this way, the receiver may hear the dialogue speech translated into the target language.

In Step S573, the processor 140 may display the translated dialogue text through the display 170. Based on the above, both parties in the dialogue may confirm the translated call content through the window screen displayed on the display 170.

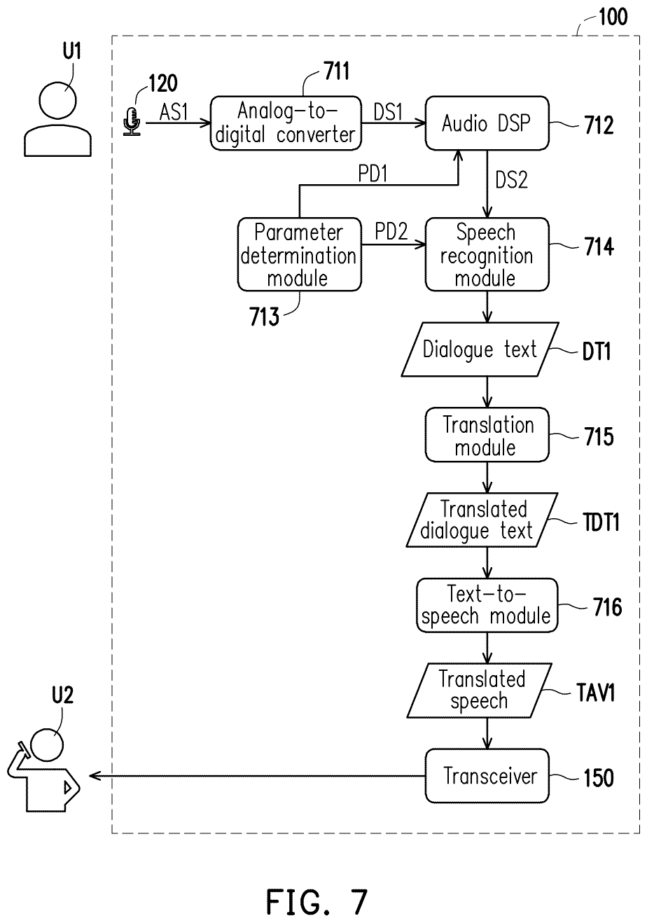

Please refer to FIG. 7, which is a schematic diagram of the real-time call translation method according to an embodiment of the disclosure. When a user U1 controls the mobile electronic device 100 to initiate a voice call and enable the call translation function, a parameter determination module 713 may dynamically determine the speech recognition parameter and the audio processing parameter based on the environmental sound level and the call mode. The parameter determination module 713 may send a parameter control signal PD1 to an audio DSP 712 to set the audio processing parameter. The parameter determination module 713 may send a parameter control signal PD2 to a speech recognition module 714 to set the speech recognition parameter.

When the voice call is connected, the microphone 120 may capture the speech of the user U1 and send an analog audio signal AS1 to an analog-to-digital converter 711 to generate digital audio data DS1. The audio DSP 712 may perform audio processing on the digital audio data DS1 according to the audio processing parameter set by the parameter determination module 713 to generate optimized digital audio data DS2. The speech recognition module 714 may perform speech recognition processing on the digital audio data DS2 using the speech recognition parameter set by the parameter determination module 713 to generate a dialogue text DT1. A translation module 715 may translate the dialogue text DT1 to generate a translated dialogue text TDT1 in the target language. Then, a text-to-speech module 716 may perform the text-to-speech processing on the translated dialogue text TDT1 to generate a translated speech TAV1. Subsequently, the transceiver 150 may send the translated speech TAV1 to a receiver U2, so as to realize the real-time translation function for the voice call.

In some embodiments, the parameter determination module 713, the speech recognition module 714, the translation module 715, and the text-to-speech module 716 may be implemented as software modules executed by the processor. The audio DSP 712 may be implemented as an audio processing chip.

In summary, in the embodiments of the disclosure, the speech recognition parameter may be determined based on the environmental sound level of the call environment and the call mode, in order to improve the accuracy of speech recognition processing based on the speech recognition parameter. In addition, the audio processing parameter may be determined based on the call mode to generate the call voice signal suitable for speech recognition processing. The dialogue text in the first language generated by the speech recognition processing may be translated into the translated dialogue text in the second language. During the voice call, a function may be executed based on the real-time translated dialogue text. As a result, in the embodiments of the disclosure, the quality of call translation can be effectively improved, making real-time translation during the call more convenient and satisfactory.

Finally, it should be noted that the embodiments are merely used to explain the technical solutions of the disclosure, and the embodiments are not intended to limit the disclosure. Although the disclosure has been described in detail with reference to the embodiments, persons skilled in the art should understand that the persons may still modify the technical solutions described in the foregoing embodiments, or make equivalent substitutions for part or all of the technical features; and these modifications or substitutions do not make the essence of the corresponding technical solutions deviate from the scope of the technical solutions of the embodiments of this disclosure.

What is claimed is:

1. A real-time call translation method adapted to a mobile electronic device comprising a microphone, wherein the method comprises:
detecting environmental sound level in response to initiating a voice call;
determining a speech recognition parameter based on the environmental sound level;
performing speech recognition processing on a call voice signal received by the microphone according to the speech recognition parameter to obtain a dialogue text;
translating the dialogue text corresponding to a first language to generate a translated dialogue text corresponding to a second language; and
executing a function based on the translated dialogue text during the voice call.

2. The real-time call translation method as claimed in claim 1, wherein the speech recognition parameter comprises an end-of-speech timeout (EOS timeout) for the speech recognition processing.

3. The real-time call translation method as claimed in claim 2, wherein determining the speech recognition parameter based on the environmental sound level comprises:
determining the end-of-speech timeout to be a first value in response to the environmental sound level being greater than a volume threshold; and
determining the end-of-speech timeout to be a second value in response to the environmental sound level being not greater than the volume threshold, wherein the second value is greater than the first value.

4. The real-time call translation method as claimed in claim 2, wherein determining the speech recognition parameter based on the environmental sound level comprises:
determining the end-of-speech timeout based on a call mode of the voice call and the environmental sound level.

5. The real-time call translation method as claimed in claim 4, wherein determining the end-of-speech timeout based on the call mode and the environmental sound level comprises:
determining the end-of-speech timeout to be a first value in response to the environmental sound level being greater than a volume threshold and the call mode being a speaker mode; and
determining the end-of-speech timeout to be a second value in response to the environmental sound level being greater than the volume threshold and the call mode being an earpiece mode,
wherein the second value is greater than the first value.

6. The real-time call translation method as claimed in claim 5, wherein determining the end-of-speech timeout based on the call mode and the environmental sound level comprises:
determining the end-of-speech timeout to be a third value in response to the environmental sound level being not greater than the volume threshold and the call mode being the speaker mode; and
determining the end-of-speech timeout to be a fourth value in response to the environmental sound level being not greater than the volume threshold and the call mode being the earpiece mode,
wherein the fourth value is greater than the third value, and the third value is greater than the second value.

7. The real-time call translation method as claimed in claim 1, wherein before performing the speech recognition processing on the call voice signal received by the microphone according to the speech recognition parameter to obtain the dialogue text, the method further comprises:
determining an audio processing parameter based on the call mode of the voice call; and
performing audio adjustment on the call voice signal received by the microphone according to the audio processing parameter.

8. The real-time call translation method as claimed in claim 7, wherein the audio processing parameter comprises a microphone sensitivity, the call mode comprises a speaker mode or an earpiece mode, and the microphone sensitivity in the speaker mode is higher than the microphone sensitivity in the earpiece mode.

9. The real-time call translation method as claimed in claim 7, wherein determining the audio processing parameter based on the call mode of the voice call comprises:
adjusting an equalizer gain corresponding to a first frequency range in response to the call mode being a speaker mode; and
adjusting the equalizer gain corresponding to a second frequency range in response to the call mode being an earpiece mode,
wherein the first frequency range is different from the second frequency range.

10. The real-time call translation method as claimed in claim 1, wherein executing the function based on the translated dialogue text during the voice call comprises:
performing text-to-speech processing on the translated dialogue text to generate a translated speech; and
sending the translated speech to a receiver of the voice call.

11. A mobile electronic device, comprising:
a microphone;
a processor coupled to the microphone, and configured to:
detect environmental sound level in response to initiating a voice call;
determine a speech recognition parameter based on the environmental sound level;
perform speech recognition processing on a call voice signal received by the microphone according to the speech recognition parameter to obtain a dialogue text;
translate the dialogue text corresponding to a first language to generate a translated dialogue text corresponding to a second language; and
execute a function based on the translated dialogue text during the voice call.
